(19) United States
(12) Patent Application Publication
(10) Pub. No.: US 2018/0110218 A1
(43) Pub. Date: Apr. 26, 2018

(54) Substrate for Controlling Flies and Other Insects, Method for Manufacturing Thereof and Use of Said Substrate as Animal Litter

(71) Applicant: María Pilar Mateo Herrero, Valencia (ES)

(72) Inventor: María Pilar Mateo Herrero, Valencia (ES)

(21) Appl. No.: 15/342,265

(22) Filed: Nov. 3, 2016

(30) Foreign Application Priority Data
Oct. 21, 2016 (ES) P201600885

(51) Int. Cl. A01N 25/08; A01N 43/40; A01N 47/34; A01N 43/68; C05G 3/02; C05F 3/00; C05G 3/00

(52) U.S. Cl. CPC A01N 25/08; A01N 43/40; A01N 47/34; B09C 1/06; C05G 3/02; C05F 3/00; C05G 3/0029; A01N 43/68

(57) ABSTRACT

A substrate designed to be used as animal litter, for controlling insects, preferably flies, in which the substrate includes an absorbent substrate impregnated with at least one insect growth regulator (IGR) in a preferred determined concentration, and where the substrate is preferably impregnated with a formulation including, in addition to the growth regulator, a film-forming substance, a water insoluble particulate mineral material, an organic solvent, one or more additives and water. A method for obtaining the substrate impregnated with the formulation is also disclosed, as well as using the substrate as animal litter for controlling insects. Use of the waste resulting from the mix of the substrate with manure, after it has been used as animal litter, as organic compost for agricultural soils by subjecting it to a process of stabilization and degradation by means of biosolarisation is also disclosed.

### CROSS-REFERENCE TO RELATED APPLICATION

This application claims priority to Spanish Patent Application No. P201600885 filed Oct. 21, 2016, the disclosure of which is hereby incorporated in its entirety by reference.

### FIELD OF THE ART

The field of the present invention is Chemistry, more specifically the area of insect control, preferably flies, in livestock farming. More specifically, the present invention provides a substrate and a method for controlling flies and other insects in animal litters and other environments where animals live in such as stables, pens, farms or zoos.

In addition, the waste resulting from using the substrate that is the object of the invention as animal litter in pens, stables, farms or zoos can be transformed by subjecting it to a process that breaks down the pesticides in order to then use it as fertilizer and organic amendment for agricultural soils. Therefore, this invention has applications in the field of Public Health, Agriculture and Animal Health.

### STATE OF THE ART

There are different species of flies, all of which are bothersome for both humans and animals, even potentially damaging their health since flies can transmit pathogenic microorganisms and parasites via mechanical means. In general, the life cycle of flies comprises four stages: egg, larva, pupa and adult fly. The housefly (Musca domestica) and the stable fly (Stomoxys calcitrans) are the most common and prolific types of flies among the different species of flies, and the ones that cause the most damage in the sector of livestock farming.

The housefly (Musca domestica L) can multiply very quickly, which can cause serious problems in places where animals live or are reared, such as cattle, horses, etc. Flies generally lay their eggs in decomposing organic matter such as, for example, moist manure or spoiled food. The housefly can multiply very quickly (for example, a pound of moist manure can host over 1,500 larvae) and quickly (in optimal conditions its life cycle can last only 6 days), with large populations of flies being able to grow even in small areas where animals are reared.

The stable fly (Stomoxys calcitrans) is a livestock plague that has spread all over the world. It is very common in bovine farms (especially for fattening cattle and milk cattle), in horses and in pig pens, but they also attack any warm-blooded animal (donkeys, mules, sheep, etc.), even humans. They are found especially on the legs, the sides and the rumps of animals. Male and female flies suck blood 2 or 3 times a day for a period of about five minutes each time. When they are not sucking blood they are generally resting away from the host, on walls or other objects near where the hosts are (poles, trees, wire fences, enclosures). Each female fly lays between 500 and 1,000 eggs on decomposing organic matter, if possible of vegetable origin: decomposing hay bales, silage waste, horse or cow manure mixed with the materials used in animals litters, etc., and rarely in pure excrement. Their hematophagous activity takes place during the day and it is an exophagous activity, that is, they sting on the outside, in open air, normally around stables, though flies can also bite inside rooms when they are forced to fast.

In addition to these two species, sometimes livestock farms and stables are host to flies of the Sarcophaga, Lucilia, Calliphora and Musca species, with the Musca autumnalis (face fly) being especially problematic, in addition to other species local to certain geographic regions such as Haematobia irritans, which is very prominent in South America.

As mentioned above, flies can transmit diseases and parasites between animals, as well as between animals and humans. More specifically, houseflies can host over 100 different types of pathogens. There are studies that have linked them with over 65 human and animal diseases. Additionally, they can transport infectious eggs and larvae of several parasitical worms. More specifically, flies can transmit viral diseases in livestock such as bovine viral diarrhoea (BVD), bovine herpesvirus (BHV-1) that causes infectious bovine rhinitis (IBR) and bovine parainfluenza 3 (PI3). Bacterial diseases caused by flies include conjunctivitis, mastitis, bacterial diarrhoea, typhoid fever, anthrax, vibriosis, and several clostridial diseases. Flies can also transmit diseases between horses, for example, the Pigeon disease or equine infectious anaemia, in addition to playing an important role in forming summer sores.

A plague of flies can cause serious financial problems for livestock farms. In particular, flies can cause a reduction in the production of milk, interfere with the job of workers, increase the frequency of diseases among livestock and, as a result, increase the expenditure on veterinary services.

Similarly, plagues of flies can also cause important financial losses in the equestrian sector since they affect both the health of horses as well as of the personnel at the stables. Large infestations of houseflies cause stress among horses, which become very nervous and agitated. In the case of horse flies (Stomoxys calcitrans L.), in addition to the problems mentioned above, they can cause other problems related to the fact that this species of fly feeds of the blood of animals and humans. Therefore, a large population of this type of species can weaken animals due to the loss of blood. In addition, the bite of this type of fly is quite painful and can occasionally cause allergic reactions, so a plague of this species of fly can negatively affect other industries such as, for example, tourism. Additionally, Stomoxys calcitrans can transmit several protozoa to horses such as Trypanosoma evansi and Trypanosoma equinum, that causes mal de las caderas or surra.

Flies are also main vectors of Habronema spp, a species of gastrointestinal nematodes common in equines that cause a disease called cutaneous habronemiasis, which causes ulcers in different parts of the animal. Since they visit many different hosts, they can also act as mechanical vectors of viral and bacterial diseases, for example, the virus of the foot and mouth disease.

In addition, there are other insects that proliferate in the materials used as animal litters since they provide excellent cover and shelter. This is the case of the litter beetle (Alphitobius diaperinus) that is usually present in facilities for raising chicken for meat consumption (fattening chickens), or the presence of different species of fleas in pens and stables of sheep, goats or cattle.

Therefore, in addition to the housefly, the following species of insects usually have their habitat in places where animals live and in livestock facilities.

| SPECIES | CHARACTERISTICS |
|---|---|
| Stomoxys | It can transmit several protozoa to horses such as |
| calcitrans | Trypanosoma evansi and Trypanosoma equinum, that |
| | causes “mal de las caderas” (in Spanish) or surra. |
| | Main vectors of Habronema spp, a species of |
| | gastrointestinal nematodes common in equines that |
| | cause a disease called cutaneous habronemiasis, which |
| | causes ulcers in different parts of the animal. |
| | They can also act as mechanical vectors of viral and |
| | bacterial diseases, for example, the virus of the foot |
| | and mouth disease. |
| Alphitobius | They proliferate in the materials used as animal litters, |
| diaperinus | especially in facilities for raising chicken for meat |
| | consumption (fattening chickens) |
| Fleas | Commonly present in livestock farms. |

Currently a combination of different control systems is used to fight against all these plagues that are present in places where farm animals live and/or are reared, such as for example livestock farms, stables, farms or zoos. Normally, this system comprises processes for sanitising the areas with the aim of reducing the breeding spots, that is, removing decomposing material where flies and other insects may grow (for example, old fodder, agricultural waste, hay, manure, spoiled food), and cleaning the facilities; biological control using the natural enemies of the plague of insects that is being controlled; and/or chemical agents.

The chemical agents for controlling plagues generally include spray insecticides, cold fogging (small drops) and spraying, direct self-application devices on animals (pour-on and spot-on), bait or traps. Applying spray insecticides on the surfaces where insects usually rest, especially flies, that is, walls, posts, ceilings and other structures, creates a toxic surface that can reduce the population of insects in the environment where animals live, in particular stables and/or pens. Other quite common alternative is to apply the insecticide compound in the form of a fog, that is, very small drops that remain floating in the air during a short period of time. This treatment can control the population of flying insects such as adult flies, since they get in contact with the insecticide while they fly in the area where the treatment has been applied. In both cases it is necessary to protect the water and the food of the animals as well as the animal themselves when the insecticide compound is applied.

It is worth highlighting that the use of larvicide products, mainly insect growth regulators (IGRs) such as diflubenzuron, novaluron, triflumuron and cyromazine has become a common practice in livestock farms. However, applying these active agents on-site by means of spraying or sprinkling manure and the litters of animals has the following drawbacks:
The treatments need to be repeated each time on new manure or on the material of the animal litter replaced when the cleaning process is carried out;
The maintenance personnel of the livestock farms needs to constantly handle biocidal products;
Incomplete coverage (and therefore non-homogeneous) of the whole surface and or volume of animal litters, since they are generally only applied over the areas where manure is present. Additionally, only the superficial layer of the litters are treated, which negatively affects the effectiveness of the larvicide;
The existence of untreated areas allows larvae and other insects that do not live in manure, such as fleas, to grow; and
The addition of abundant moisture to manure and the material of the litters by means of spraying makes them more appealing places for oviposition of flies and for fungi to proliferate in animal litters.

Fly larvae can also be eliminated by adding insecticide to animal fodder. Adding insecticide to drinking water is less effective due to the disparate quantities of water that animals consume and to the difficulty of providing the appropriate dose for each animal.

These methods usually show residual problems that are present in animal tissues or products.

Finally, the biological control methods that consist of using predators and parasitoids (mites and beetles that feed on the eggs and larvae of flies and hymenoptera parasitoids) show the best results with dry manure. In moist manure, predators are not able to move effectively to find and eat the eggs and larvae of flies. As for the use of entomopathogenic fungi, they have proven to be effective against flies but most species are only active on adult flies. Some species such as Beauveria bassiana have a wide range of activity (for example, they can infect many species of insects), while others are more selective (for example, Metarhizium anisopliae and Paecilomyces fumosoroseus are more effective against the face fly and the horn fly).

Using conventional insecticides to control plagues of flies and other insects has several drawbacks. One of the most important is that flies quickly develop resistances to the insecticides used, so if these chemical agents are used, it is necessary to alternate or rotate between the different types of insecticides. Additionally, there are currently new regulations that establish a reduction in the levels of insecticides present in food, as well as in the levels to which humans and animals are exposed. Although the methods that comprise using insecticides in the shape of traps, sprays or fog can reduce the number of adult flies, they obtain limited results since it is not possible to keep the number of flies at acceptable levels during a long period of time. In consequence, there is a need for an improved method for controlling flies that prevents them from growing in those places were animals live and/or are reared, especially cattle, horses or wild animals in confinement.

Correctly choosing the material used for the litter of the animal can be helpful for controlling plagues of flies or other insects in those places where animals live and/or are reared. Therefore, it is for example preferable to use wood shavings as absorbent substrate instead of hay or straw, since the latter absorb urine and quickly decompose, turning the animal litter in an ideal place for insects to grow, particularly flies. In order to avoid this, when hay or straw is used as the material or absorbent substrate giving shape to the animal litter, it is necessary to remove the material used more frequently than when wood shavings are used.

Correctly choosing the material or substrate comprising the litter of an animal is important to make the animal live in a comfortable and healthy environment. The multiple functions of this material include absorbing urine and gases, as well as reducing the proliferation of bacteria. Absorbent substrates that can be used as animal litters include wood shavings, wood pellets, peat, hay or straw, newspapers scraps or alternative materials such as, for example, rice shells, wheat sub-products, etc. It is easy to remove any of these materials from the stables and/or pens once they are contaminated with urine, manure or any other type of waste generated by the animal, so that the animal can be kept in a healthy environment.

Currently, part of the waste generated when the portion contaminated by manure is removed from the litters of animals, especially from stables, pens or farms, can be used as an organic fertilizer in crop fields, for example, in fields of sugar cane. However, up to now this waste is not subjected to any previous treatment in order to eliminate the bacteria that may be present in the excrement contained in the absorbent substrate, and the insecticides that may have been placed on the litters after treating them with sprays or fog are not eliminated either, including larvicides applied directly on-site on the soil, litter and/or manure in order to control plagues of flies and other insects that live in the environment of animals. Therefore, directly applying this waste as fertilizer may cause public health problems and/or environmental pollution.

The presence of pesticides in soils constitutes an environmental problem in different environmental areas such as run-off waters, subterranean waters by lixiviation and emissions to the air by volatilization. Additionally, these substances may affect microorganisms in the soil, beneficial insects and cause harmful effects on plants. Most of the benefits these substances provide to the soil are generated from farmers applying phytosanitary products when they have to fight against plagues and diseases in their agricultural crops.

The dynamics of phytosanitary products in the soil is regulated by several physical, chemical and microbiological processes. More specifically, process of adsorption/desorption, lixiviation, chemical and microbiological degradation, plant absorption, volatilization, rain, climatic factors (humidity and temperature), solar radiation and the processes contained in organic matter.

### DESCRIPTION OF THE INVENTION

The present invention provides a substrate specially designed to be used as animal litter, which allows to control the biological cycle of insects, preferably flies, preventing them from developing into the adult state and, in consequence, it can control the plagues of these insects in places where animals live and/or are reared, especially in stables, pens, farms or zoos; as well as in places where the waste generated by these animals is stored.

More specifically, the present invention refers to a substrate for controlling insects, preferably flies, in which it includes an absorbent substrate impregnated with at least one insect growth regulator (IGR). This substrate is therefore a material treated with said growth regulator. The terms “material or substrate treated” and “material or substrate impregnated” are interchangeable in the scope of the present description since the former is better suited to the nomenclature of the regulatory framework of biocides, while the latter is a technical term more commonly used and accepted when referring directly to the way in which the product is treated (impregnated) with the regulator.

Therefore, in the substrate for controlling insects, preferably flies, described in this document, one or several insect growth regulators (IGR) are distributed homogeneously on the surface of the absorbent substrate. In this way, using the substrate of the present invention as absorbent material in animal litters can achieve a controlled and easily reproduced high rate of effectiveness for controlling plagues of insects, preferably flies, in facilities where animals live and/or are reared such as pens, farms, stables or zoos, solving the problems detected in the technical field derived from applying on-site these active agents directly on manure and the litters of animals.

In the present invention, the absorbent substrate can be selected from among those known as absorbent materials for animal litters. Preferably, the absorbent substrate included in the substrate for controlling insects, preferably flies, of the present invention (and that is impregnated with the formulation) is selected from the group comprised of wood shavings, hay, wood pellets, paper, hemp, flax, ground cardboard and a combination thereof. More preferably, the substrate is made of wood shavings, more specifically pine or fir. The wood shavings are not edible; they are widely available and can be purchased in sacks and in bulk.

The substrate for controlling insects, preferably flies, described in this document includes at least one insect growth regulator (IGR), also known in the sector by the acronym IGR in English. IGRs are natural or synthetic products with a structure very similar to certain hormones that regulate the growth of arthropods. Their effect is to interfere in the development of larvae, preventing individuals from completing their reproductive cycle. Since they are substances similar to those of arthropods themselves, they do not generate any resistances.

It is worth highlighting two main types of IGRs.

A first type is made by chitin synthesis inhibitors. These compounds interfere in the formation of chitin in the stages of molting. In consequence, they prevent normal growth since the structure of the exoskeleton cannot be re-established correctly after molting takes place, which produces malformations. The most commonly used chitin synthesis inhibitors are diflubenzuron, triflumuron, lufenuron, hexaflumuron, novaluron, chlorfluazuron, teflubenzuron and cyromazine. This type of insecticides is mainly efficient when it is applied in the first larval stages (L1, L2). Most are synthesised products but there are some products of vegetable origin such as plumbagin, obtained from the roots of Plumbago capensis, which inhibits chitin synthetase, and which has proven to be effective on several plagues of lepidoptera. Cyromazine is one of the preferred cases among chitin synthesis inhibitors IGR, and it belongs to the group of triazine derivatives, which acts by interfering in the metabolism of chitin by the insect. Cyromazine is very specific for larvae of diptera (flies, calliphoridae, mosquitoes, fleas, and some coleoptera among others), which can provide an advantage since it does not damage many other species of insects and other beneficial organisms such as the parasites and predators of other plagues of insects. Additionally, cyromazine has a very low toxicological profile, and is even used in fodder as food additive.

A second type of IGR is made by those analogue and antagonist of the juvenile and molting hormone. These compounds modify the levels of the juvenile and molting hormone, preventing the insect from developing and moving on to the adult phase, so the insect dies without being able to reproduce. Therefore, those analogue to the juvenile hormone, or juvenoids, prevent the insect from completing its metamorphosis since they inhibit adult traits from differentiating and therefore prolong the larval stage, affecting fertility. They can be substances produced by the insects themselves or artificially synthesised to induce molting, causing the appearance of infertile individuals with characteristics between larva and pupa; feeding inhibition that causes diminished reproductive potential and other physiological alterations. Additionally, the juvenile hormone analogues, also known as JH analogues, can also have an ovicidal effect.

The preferred JH analogues can be selected from the group of pyriproxyfen, methoprene, fenoxycarb and a combination thereof.

It should be noted that there is a third group of compounds that operate by also affecting one of the hormones of the insects, more specifically ecdysone or molting hormone. These compounds are considered here as another type of IGR since they act as growth regulators, antagonists of the ecdysone, and are quite specific against lepidoptera. They do not raise the contents of ecdysone such as benzoylphenylurea, but instead they act directly on tissues; that is, they force a premature synthesis of the cuticle before the insect is, due to its development, prepared to molt. It is an original way of operating based on miming the action of the molting hormone: 20-hydroxyecdysone. This behaviour sets it completely apart from the insect growth regulators and inhibitors: it starts the process of molting when the insect is in the larval stage, stages L1-L4, but it is not physiological prepared for it, causing the deaths of larvae in the state of double cephalic capsule. The larvae treated quickly stop feeding after ingesting it, after 2-4 hours, which stops the damage they cause. In general, it has a low ovicidal action but it varies with each species; moreover, the product applied causes a reduction in the fertility of the adults by altering their reproductive capability. The preferred ecdysteroids are: tebufenozide, metoxifenocide, halofenozide or a combination thereof.

The insect growth regulator (IGR) present in the substrate for controlling insects, preferably flies, described in this document prevents the normal development of flies from the eggs placed on the excrements of animals resulting by the close contact between the substrate and the manure of the animals on the litter. Preferably, of all the types mentioned above that are valid for the present invention, the insect growth regulator is selected from the group of pyriproxyfen, methoprene, hydropren, diflubenzuron, triflumuron, fenoxycarb, tebufenozide, metoxifenocide and cyromazine, and a combination thereof. Even more preferably, the IGR is pyriproxyfen due to its effectiveness in low doses, low toxicity for mammals, and high speed of degradation in soils. Another insect growth regulator preferred due to its properties and behaviour in the present invention is cyromazine.

Pyriproxyfen is a wide ranging insect growth regulator that acts against plagues of insects such as the house fly, mosquitoes and cockroaches. IGRs are specific for insects and have a very low toxicity for mammals. Pyriproxyfen is one of the four pesticides (together with temephos, metoprene and permetrin) recommended by the World Health Organization for treating drinking water against plagues of mosquitoes.

As mentioned above, flies and other insects lay their eggs in decomposing organic matter such as, for example, the manure on animal litters in stables and/or pens. Currently, the substrate used as animal litter in stables and/or pens, preferably wood shavings, is periodically removed, replaced and stored before it is reused as organic fertilizer. During this entire time, the eggs laid on manure mature and cause the problems of other plagues of insects.

Against these drawbacks, manufacturing the treated absorbent substrate used in animal litters by impregnating it with IGR affects the development of the eggs of flies present in manure, even being able to achieve 100% effectiveness when using pyriproxyfen in particular, since it prevents flies from progressing from the juvenile states (larva and pupa), preventing the adult insect from appearing. As explained above, this effect cannot be achieved when the active agent is applied by means of spraying or similar on a substrate on-site for the reasons detailed in the previous paragraph (non-homogeneous application, untreated areas, etc.).

In the preferred embodiments of the present invention, the concentration of the insect growth regulator, preferably pyriproxyfen, impregnated in the absorbing substrate, is between 1 mg/kg and 6000 mg/kg, with both quantities relating to the weight of IGR in relation to the weight of the absorbent substrate. This quantity is equal to 0.0001-0.6% of the final weight of the substrate, and these values express the concentration of the active ingredient in the absorbent substrate, which can be defined as IGR “load” in the substrate. Preferably, the concentration of the insect growth regulator impregnated in the absorbent substrate is between 1 mg/kg and 500 mg/kg. More preferably, the quantity of IGR by weight in relation to the total weight of final substrate is 0.0015%.

It is hereby highlighted that this interval of values as well as any disclosed in the present description and the minimum and maximum values disclosed are included as part of the invention.

In the preferred embodiments of the present invention, the absorbent substrate is impregnated with a formulation including the following quantities disclosed by weight in relation to the total weight of the formulation:
between 0.005 and 10% of at least one insect growth regulator (IGR);
between 0% and 5% of at least one film-forming substance;
between 0 and 15% of at least one water insoluble particulate mineral material;
between 0% and 25% of at least one organic solvent;
between 0.01 and 10% of at least one additive selected from the group of emulsifier, thickener, pH regulating agent, antifoaming agent, dispersant, preservative, fungicide, and a combination thereof; and
the quantity of water sufficient to complete 100% of the weight of the formulation.

In particular embodiments of the present invention, the qualitative and quantitative composition of the ingredients of the formulation impregnated in the absorbent substrate correspond to the composition of the formulation including the IGR used to manufacture the substrate of the invention, though it is possible that the quantity of water content and, possibly other volatile ingredients such as solvents may decrease during the application of a possible drying stage applied during the method of manufacturing the substrate of the present invention, or due to the air or heat in the environment where it is used.

Preferably, at least one insect growth regulator (IGR) is made in the formulation in a quantity by weight between 0.001% and 10% in relation to the total weight of the formulation, with the preferred weight being 0.05% when the IGR is pyriproxyfen. Naturally, this value will vary and depend on the nature of the IGR used. Therefore, in the case of cyromazine, which is also preferred, the preferred concentration would be between 0.05% and 5%, and more preferably is 0.5%.

Preferably, the film-forming substance may be between 0.1% and 2% by weight of the total weight of the formulation. This film-forming substance included in the formulation impregnated in the substrate described in this document can be, for example, vinyl acetate homopolymers, acrylic acid homopolymers, or copolymers including the following monomers: vinyl acetate, acrylic acid, styrene, vinyl versatate, ethylene, vinyl chloride and butadiene, among others; they may also be thermoplastic polyurethanes; natural or modified cellulose; natural or synthetic film-forming resins such as turpentine, colophony, alkydic or acidic resins. Preferably, the film-forming is a vinyl copolymer.

Additionally, the formulation including the IGR may include a water insoluble particulate mineral material such as talc, kaolin, calcium carbonate, calcium sulphate, bentonite, sepiolite, among others. Preferably, this formulation includes calcium carbonate. Preferably, this component accounts for 0.1 and 5% by weight of the total weight of the formulation.

Additionally, the organic solvent may be between 0.1 and 5% by weight of the total weight of the formulation. The preferred solvents used in the present invention belong to the group of hydrocarbons, alcohols, esters, ethers, ketones, amines, aliphatic amides or aromatic amides.

In the preferred embodiments of the invention, the formulation including at least one IGR may also include one or more of the following additives disclosed in % of the total weight of the formulation:
emulsifying agent, preferably a calcium salt of alkylbenzene sulfonic acid, between 0.1-10%;
thickener, preferably a cellulose compound, between 0.1-2%;
pH regulator, preferably an acetic-acetate buffer, between 0.1-1%;
antifoaming agent, preferably selected from among mineral oils, between 0.1-2%;
dispersant, preferably a polyacrylic acid derivative, between 0.1-5%;
preservative, preferably an isothiazolinone, between 0.1-1%; and/or
fungicide, preferably tebuconazole, between 0.1-1%;

These additives can act as stabilisers of the formulation, both before it is applied impregnating the absorbent substrate as well as after it has been impregnated in the absorbent substrate, which means that these additives keep the formulation stable when it is impregnated in the substrate.

Additionally, the present patent application refers to a method for obtaining the substrate for controlling insects, preferably flies, described in this document, in which the method includes: applying (in a homogeneous way by impregnation) a formulation on an absorbent substrate, the formulation including the following quantities, in percentages by weight of the total weight of the formulation:
between 0.005 and 10% of at least one insect growth regulator (IGR);
between 0% and 5% of at least one film-forming substance;
between 0 and 15% of at least one water insoluble particulate mineral material;
between 0% and 25% of at least one organic solvent;
between 0.01 and 10% of at least one additive selected from the group including emulsifier, thickener, pH regulating agent, antifoaming agent, dispersant, preservative, fungicide, and a combination thereof; and
the quantity of water sufficient to complete 100% of the weight of the formulation.

From the description above it is evident that any of the possible alternatives of the formulation like the ones described in this document can be applied in the essential method, and this formulation is impregnated as desired in order to remain in the final substrate.

However, in an alternative of the method, this formulation that is impregnated can be found in the form of concentrated raw material, which makes it easier to store, package, distribute and sell, so that in this particular case the method may include a previous stage of diluting the concentrated formulation in water in order to obtain the usage dose, that is, in order to be able to apply it to impregnate the substrate. In this case, the method may include a stage of diluting a concentrated formulation in water that includes the following components disclosed as weight of the total formulation:
between 1 and 50% of at least one insect growth regulator (IGR);
between 0% and 25% of at least one film-forming substance;
between 0 and 50% of at least one water insoluble particulate mineral material;
between 0% and 95% of at least one organic solvent;
between 0.01 and 10% of at least one additive selected from the group including emulsifier, thickener, pH regulating agent, antifoaming agent, dispersant, preservative, fungicide, and a combination thereof; and
the quantity of water sufficient to complete 100% of the weight of the formulation, which may be equal to zero, before applying the said formulation impregnating the substrate homogeneously.

In this way, it is hereby clarified that the formulation containing the IGR and that is impregnated in the substrate is aqueous, and in some cases instead of being ready to use, it may be in its concentrated format. The concentrated version, containing a concentration of IGR between 1% and 50%, needs to be diluted in water before it is applied, and a shaken container can be used to do so. Alternatively, the concentrated product may be diluted in a current of controlled dilute water volume, carrying out inline dilution in order to apply it directly without having to dilute it in a container.

It should be noted that based on the values given above, there is an overlapping of values between the interval of IGR concentrations in the ready-to-use formulation and the concentrated formulation, more specifically between 1% and 10%. This is due to the different effective doses needed for each of the IGRs described herein, that may be part of the invention. Therefore, it is evident that an IGR with a determined percentage by weight in the ready-to-use formulation will always have a higher concentration in the concentrated formulation, while this concentration may be higher or lower in relation to a different IGR. In this way, it is possible that between 1% and 10% by weight of IGR, the formulation may be directly impregnated in the substrate or previously diluted, depending on the IGR it contains.

In a preferred embodiment, the concentration of the IGR in the ready-to-use formulation is between 0.005% and 1% of the total weight of the formulation, including both limits, when the IGR is pyriproxyfen, and the quantity of IGR in the concentrated formulation is preferably between 1% and 10%.

In the preferred embodiments of the present invention, the formulation including the IGR can be applied on the absorbent substrate, preferably wood shavings, in one of the following doses:
Ready-to-use formulation dose: 2-10% by weight of the weight of the absorbent substrate.
Diluting the concentrated formulation: diluting 0.5-20% in water and then applying it on the material in doses of 2-10% by weight of the weight of the absorbent substrate.
IGR concentration in the ready-to-use formulation: 0.005-10%, preferably between 0.01% and 2%; IGR concentration in the concentrated formulation: 1-50%, preferably between 5% and 25%;
IGR concentration in the wood shaving: 1-6000 mg/kg or 0.0001-0.6%, preferably between 1 mg/kg and 500 mg/kg.

At this stage, it is worth highlighting that if the formulation to be impregnated includes pyriproxyfen as IGR, then in the preferred embodiment said IGR is between 0.01% and 0.01% by weight of the total weight of the formulation, being more preferably of 0.05%. Additionally, in a preferred manner the dose of said formulation applied on the substrate is 15 mg/kg of substrate (preferably wood shavings). In the case of cyromazine, the preferred diluted concentration for impregnating the substrate is 0.5%, and with a load of 150 mg/kg of substrate.

The substrate impregnated with IGR described in this patent application is especially suited to be used as a component of the litter of horses and other animals, and therefore it must have a low level of humidity in order to be able be absorbent, and also so that it can control the immature stages of flies in manure; in this description, a “low” level of humidity should be understood as comprising between 8% and 12%, and never any value higher that those. Therefore, the quantity of formulation (dose) used for impregnating the substrate is as an important a parameter as the concentration of IGR (preferably pyriproxyfen or cyromazine) of the formulation, since the lower the dose, the lower the humidity of the final product.

The formulation can be applied on the substrate by means of one of the techniques selected from among the group including sprinkling, spraying, fogging or direct contact with a surface impregnated with the formulation. Preferably, the method of the present invention applies the formulation by means of spraying.

More specifically, the absorbent substrate, especially wood shavings, is impregnated by several means or different combinations thereof. Specifically, one of the following methods can be applied:
Spraying the formulation including the IGR by means of nozzle diffusers with a droplet size varying between 1 and 200 micrometers with the help of a pump;
the formulation including the IGR by means of compressed air or pumping;
Direct contact with a roller soaked in the formulation including the IGR.

In order to do so, the impregnating system may be based on the absorbent substrate advancing and moving through different means or a combination thereof as the formulation including the IGR, preferably pyriproxyfen, is applied:
Gravity feeding the absorbent substrate by means of a duct with or without using deflectors to divide the flow in the shape of curtains in two or more fractions;
Advancing through an inclined plane by means of a fluidised bed moving the absorbent substrate by pneumatic action;
Advancing through an inclined shake table; and/or
Advancing through an inclined trommel rotating and turning the absorbent substrate; this is the preferred system since it is ideal for transporting and constantly moving the material, causing it to separate and change sides as it turns.

In the substrate for controlling insects, preferably flies, obtained by the method described in this patent application, the IGR is distributed homogeneously so that the active ingredient is conveniently distributed on the surface of the substrate.

In the manufacturing method disclosed in this document, when the substrate impregnated with the formulation including the insect growth regulator has a humidity above 12%, the method includes an additional stage in order to dry the impregnated absorbent substrate to a maximum humidity value of 12%, so that it is not above 12% and preferably remains between 8%-12%.

Drying the impregnated material (substrate) can be carried out by different means or a combination thereof. More specifically, one of the following means or a combination thereof can be used:
Convection drying through hot airflow from a burner or a system for heating air by other means. Alternatively, room temperature air can be used (that is, between 20° C. and 30° C.) if the need for drying the substrate is lower. This is the system preferred due to its cost and simplicity when applying it at an industrial level, as well as due to using lower temperatures than hot radiant systems, so that the material is prevented from degradating;
Radiant drying by means of infrared burners, electric resistances or infrared radiation.

One of the following systems or a combination thereof may be used with the aim of obtaining better homogeneity when impregnating the IGR in the absorbent substrate, preferably wood shavings:
Suspending the absorbent substrate by means of pneumatic action in a chamber with the formulation including the IGR sprayed in small drops. Additionally, the movement may be aided by means of eccentric vibration of the support table;
Gravity feeding the absorbent substrate by means of a duct using deflectors to divide the flow and spraying from various points the formulation including at least one IGR;
Shaking and moving the absorbent substrate by means of a worm screw inside a chamber and spraying the formulation in sequences along the substrate;
Turning the absorbent substrate by means of brushes on a conveyor belt and spraying the formulation in sequences along the substrate;
Turning the absorbent substrate by means of rotating and moving the material inside a cylinder. This is the preferred system due to its separating effect and the frequency of turning achieved.

In other preferred embodiments, the absorbent substrate are wood shavings and the manufacturing method for controlling insects also includes manufacturing these wood shavings. In general, the process of manufacturing wood shavings may include the following stages:

a) cutting or shaving the surface of logs of wood, preferably pine or fir, in order to create wood flakes of a thickness between 0.5 and 2 mm;

b) drying them, for example in hot air driers, in order to reduce their humidity content, preferably up to a maximum humidity content of 12% of the total weight of the wood shavings;

c) purifying in order to eliminate dust and small particles; and

d) packaging, for example, in sacks or in bulk.

The purification stage c) may be carried out, for example, by means of a cyclone and sieve. The small particles separated at this stage can be used as fuel in biomass burners that feed hot air to the drier in the stage b) of drying the flakes.

Alternatively, this process of obtaining wood shavings can be reduced to just cutting and packaging the wood for lower quality products.

In the preferred embodiments, the wood shavings, preferably pine or fir, used to obtain the substrate for controlling insects, preferably flies, described in this patent application has a humidity content between 8% and 12% by weight of the total weight of the wood shavings.

In the substrate for controlling insects, preferably flies, disclosed in this document, the IGR can be applied on the wood shavings at any stage of the manufacturing process of the wood shavings, preferably after purifying them by means of the sieve. In this way, the absorbent substrate is only handled at the end so that it avoids generating atmospheric emissions while the impurities are burned (dust and small particles), which would take place if the formulation was applied to the wood shavings before the stage of purification.

The process to impregnate the substrate is carried out preferably alongside the normal production of the wood shaving, inserting an unit to be impregnated in the process (see FIG. 1), though it can also be carried separately to the manufacturing process on the finished wood shaving. Including this stage in the production line provides advantages in regards to the cost of the process and the simplicity of the operation.

The present invention also discloses the substrate for controlling insects, preferably flies, obtained through the manufacturing method described in this patent application. This substrate has a particularly homogeneous distribution both of the IGR as well as the other components that may be present in the impregnation formulation, so that they are especially beneficial when using them to control plagues of insects, preferably flies, in places where animals live or are reared.

Additionally, the present invention discloses the use of the substrate for controlling insects, preferably flies, described in this document as animal litters. More specifically, for species such as horses, cattle, sheep, pigs, goats or other wild animals in confinement, preferably horses. Preferably, the substrate for controlling flies that is the object of the invention is used as animal litters in stables and pens.

This treatment for the substrate used in animal litters prevents flies and other insects from developing normally from the eggs laid in the excrements of the animals on the litters.

Additionally, the present invention refers to animal litters formed by the substrate for controlling flies and other insects disclosed in this document. Preferably, when the substrate includes wood shavings impregnated in pyriproxyfen, the concentration of pyriproxyfen is between 1 and 100 mg/kg, and is distributed homogeneously and uniformly on the wood shavings.

The present invention also discloses a method for obtaining animal litters including placing the substrate for controlling flies and other insects described in this patent application in the place where animals live, preferably pens, stables and farms. In preferred embodiments of the present invention, this method also includes manufacturing the substrate, especially the substrate including wood shavings and pyriproxyfen, as described in this document.

In the last few years several techniques have been developed to decontaminate polluted soils by means of the degradating effect of microorganisms on the pollutants. Solarisation and biosolarisation stand out among these techniques of bioremediation of polluted soils using phytosanitary products since in most cases the degradation of these compounds in the soil is accelerated (Solarisation enhances dissipation of carbendazim (MBC) in soil, Yarden et al., Soil Biology and Biochemistry. 21 (1989), 857-861).

Soil solarisation was first described as a method for disinfecting soils of a large number of fungi, nematodes, phanerogamic parasitic plants (weeds) or plagues of arthropods, bacterial diseases, a series of diseases, microorganisms linked to weakness and other biotic or abiotic damaging agents. As a consequence, applying solarisation techniques in agricultural soil can increase the yield and improve the quality of the crops.

However, the process of solarisation for disinfecting soils has several problems, especially the gradient of temperature between the centre of the treatment (higher temperature) and outer margins of the surface covered (normal temperature), which causes the temperature to decrease progressively from one meter of the edge to the limit. The loss of effectiveness in this marginal area must be avoided. The gases escaping on the edges may also reduce the effectiveness.

The literature also describes adding manure or agricultural waste to improve the process of solarisation for disinfecting soils. In this technique called biosolarisation, the volatile substances produced by decomposing organic matter have a positive effect controlling the pathogens in the plants. Finally, increasing the quantity of organic matter in the soil provided by the biosolarised manure to the soil increases its fertility, improves its structure, and reduces salinity problems.

The results found show that using organic amendments in biosolarisation can accelerate even further the process of degradation of the insecticides primicarb and pyriproxyfen in the soil (Rate of loss of insecticides during soil solarisation and soil biosolarisation. José Fenoll, Encarnación Ruiz, Pilar Hellin, Carmen M. Martinez, Pilar Flores. Journal of Hazardous Materials 185 (2011) 634-638) and also several fungicides (Solarisation and biosolarisation enhance fungicide dissipation in the soil. José Fenoll, Encarnación Ruiz, Pilar Hellin, Simon Navarro, Pilar Flores. Chemosphere 79 (2010) 216-220).

In relation to the above, the present invention refers to a later stage of biosolarisation of the substrate of the litters (described above as object of protection) together with the manure removed from the pens, farms or stables. It essentially includes accumulating said substrate in open air enclosures and placing a transparent plastic sheet in order to make the solar radiation increase the temperature inside significantly, causing the active ingredients to degrade, preferably pyriproxyfen, so that the mixture of substrate and manure can be perfectly useful later for agricultural fertilization at no risk to the crops and the soil.

This process of appreciation can include first of watering the waste under treatment and then placing a transparent plastic to provide the adequate humidity, preferably between 40 and 60%, in order to achieve the optimum temperature at the heart of the material. The type of plastic used is preferably a low density polyethylene sheet of a thickness between 25 to 100 micrometers. Preferably this sheet is used as covering material due to its price, resistance to tension and transparency to radiations.

This process of appreciation is applied on the present invention directly on the mixture of manure and absorbent substrate for controlling insects with the aim of stabilising the organic matter, eliminating pathogens and parasites, and finally degradating the pesticides contained in the waste. The increased temperature and large concentration of microorganisms accelerate the processes of degradation and their performance. In this way, the waste comprised of manure and the substrate for controlling insects of the present invention can be used as fertilizer or organic amendment, without causing problems to public health and/or environmental pollution.

### BRIEF DESCRIPTION OF THE FIGURES

FIGS. 1a and 1b: This illustration represents the method of manufacturing the substrate for controlling insects of the present invention, including wood shavings as absorbent substrate, and the method additionally includes manufacturing the wood shavings from logs. This illustration is subdivided in two figures, FIG. 1a and FIG. 1b, FIG. 1a showing specifically the part of the method that includes cutting the surface of the wood and then drying the wood shavings as well as the purification process that follows, while FIG. 1b shows how the process continues by impregnating the formulation and then treating and packaging it.

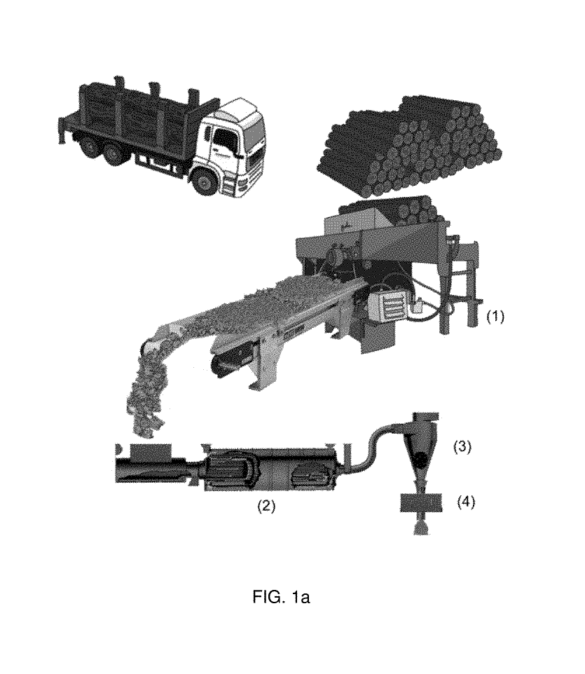

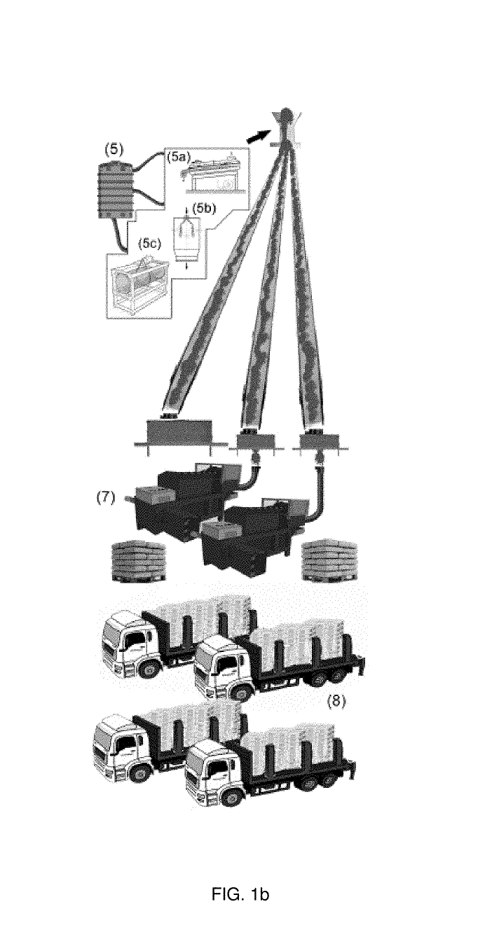

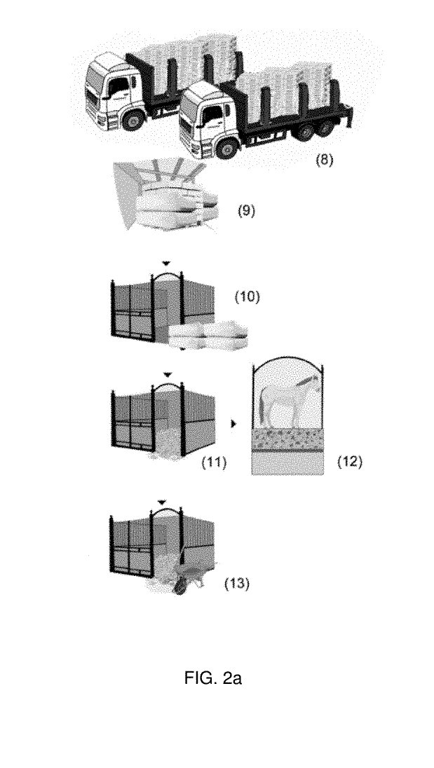

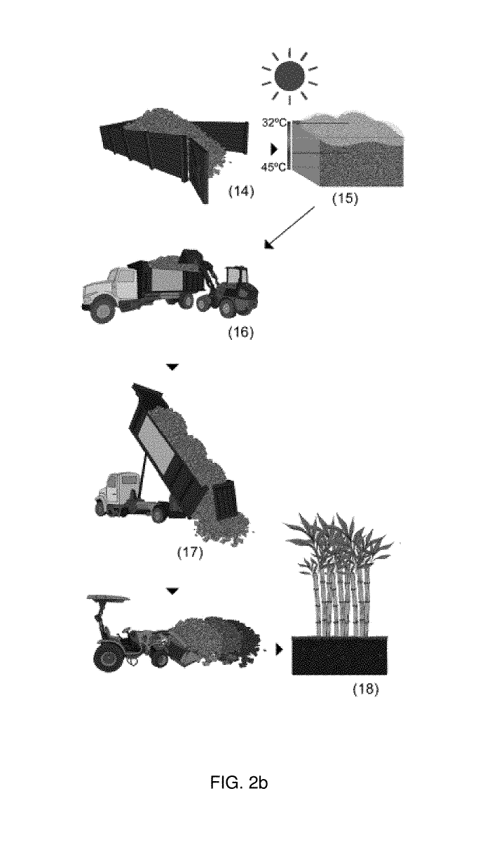

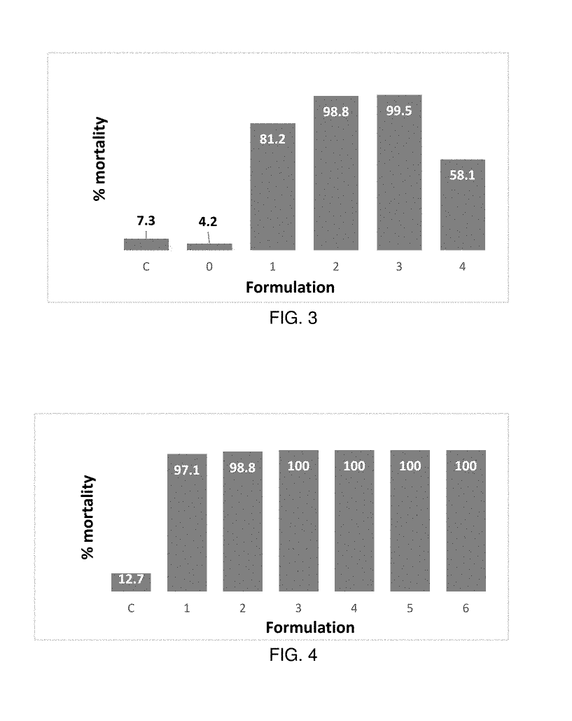

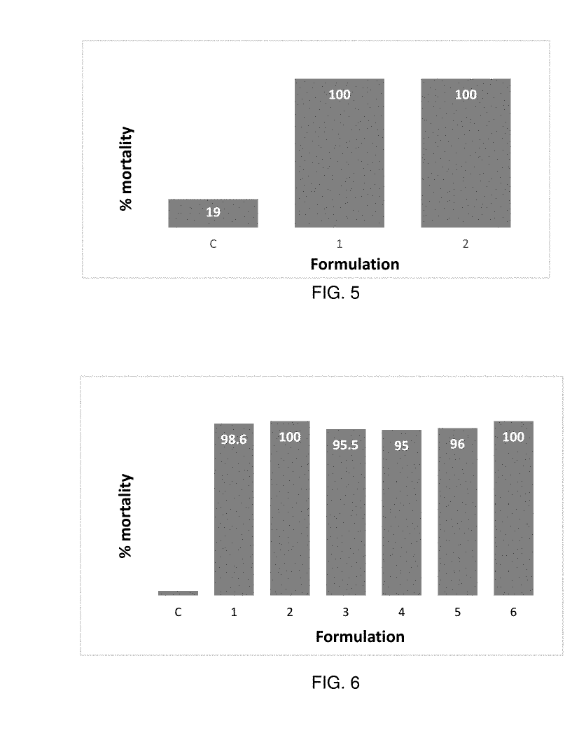

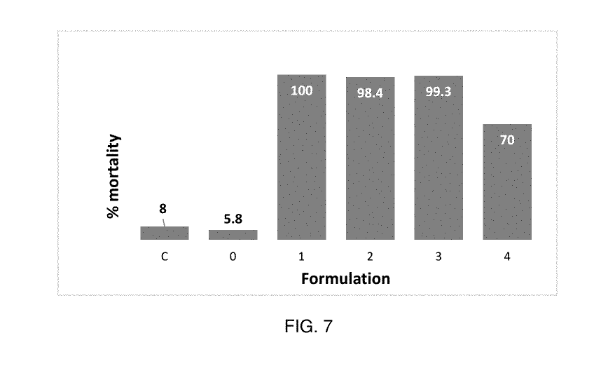

Therefore in the preferred embodiments of the manufacturing process of the wood shavings impregnated with IGR disclosed in this document, the logs of wood go through a mill (1) in which the surface of the logs is cut or shaved in a controlled way in order to obtain think flakes (shavings) of wood in a controlled process; the wood shavings go through a drying area (2), and then they are subjected to a process of purification by sifting using a cyclone (3) and a sieve (4). The impregnation area (5) is located at the outlet of the sieve (4), and this area includes a tank with the formulation including IGR (6), systems for applying the formulation from the tank of the impregnation system, where said impregnation system can be either an inclined plane by means of a fluidised bed moving the wood shavings by pneumatic action (5a), spraying the formulation including the IGR by means of diffuser nozzles (5b), or rotating and turning the material by means of a cylinder and spraying the formulation including the IGR (5c). In any of the three options, the formulation including the IGR is administered from a tank (6). Afterwards, the wood shavings impregnated with the formulation that includes at least one insect growth regulator are directed towards a packaging area (7) where they are packaged in sacks of the desired size or they are stored in bulk, and distributed by means of trucks (8) or any other transport system.

FIGS. 2a and 2b: This illustration shows how the substrate for controlling insects as litters for horses is used, and how the substrate with the excrements are collected afterwards for the process of biosolarisation to increase the value of the animal litters. This scheme is subdivided in two figures, FIG. 2a and FIG. 2b. FIG. 2a shows specifically the part of the process that includes the distribution, storage, and inclusion to the stable as animal litters, that is, its usage. Then FIG. 2b shows how this litter, after it has been used, is removed from the stable as waste for the biosolarisation treatment.

In the preferred embodiments of the present invention, the wood shavings impregnated with the IGR are distributed by means of trucks (8) or any other means of transportation to a storage area (9) until they are used. In one of the preferred applications, the wood shavings impregnated with IGR of the present invention are taken to a stable (10) and deposited on a manger (11) as the animal litter for a horse (12). After a certain time, the manger (13) is cleaned, and the waste resulting from the horse excrements and the wood shavings removed from the manger are stored in a warehouse (14). Afterwards, this waste is subjected to a process of biosolarisation (15) in which both the IGR present in the shavings and the microorganisms that may be present in the organic matter are eliminated. Finally, the waste treated is extracted from the biosolarisation warehouse (16) and is used as organic fertilizer in agricultural crops (17).

FIG. 3 is a graph showing the results of pupal mortality of M. domestica with wood shavings impregnated with the formulations detailed on table 1, as described in test 1.

FIG. 4 is a graph showing the results of pupal mortality of M. domestica with wood shavings impregnated with the formulations of pyriproxyfen detailed on table 3, as described in test 2.

FIG. 5 is a graph showing the results of pupal mortality of M. domestica with wood shavings impregnated with the formulations of pyriproxyfen detailed on table 5, as described in test 3.

FIG. 6 is a graph showing the results of pupal mortality of M. domestica with wood shavings impregnated with the formulations of pyriproxyfen detailed on table 7, as described in test 4.

FIG. 7 is a graph showing the results of pupal mortality of M. domestica with wood shavings impregnated with the formulations of cyromazine detailed on table 9, as described in test 5.

### DETAILED DESCRIPTION OF DISCLOSURE

### Examples

Firstly, four tests are described aimed at evaluating quantitatively the effectiveness of different formulations of pine wood shavings impregnated with IGRs on larvae and pupae of house fly (Musca domestica, L.). The first test was useful to prove the effectiveness of the substrate obtained and to select pyriproxyfen as the active ingredient (IGR), while the second, carried out like the first one on excrement of rabbits, was useful to choose a specific type of impregnation formulation to refine the ideal concentration and dose. The results of the second test were confirmed in the third test on horse excrement. The fourth and last test was useful to refine the optimum concentration of pyriproxyfen in the impregnation formulation (0.05% by weight of the total weight of the formulation) and the dose applied (15 mg of pyriproxyfen per kilogram of wood shavings). The results obtained show the effectiveness of the treatment for the products and doses tested, with the pyriproxyfen being the active ingredient displaying the best effectiveness, even at very low doses.

Secondly, a test is described aimed at evaluating qualitatively the effectiveness of different formulations of pine wood shavings impregnated with cyromazine on larvae and pupae of house fly (Musca domestica, L.).

### Materials and Methods

The absorbent substrate impregnated were wood shavings of the “Great Northern” pine tree, which are the most commonly used for horse litters.

For the effectiveness studies, the formulations for impregnating the wood shavings were applied manually by means of a container with a spray gun. Several sprayings were carried out, turning the wood shavings halfway to ensure that they were homogeneously impregnated.

The organic matter used was rabbit excrement in the first two tests with pyriproxyfen, due to its increased availability and high infestation with fly larvae. For tests 3 and 4 with pyriproxyfen and the test carried out with cyromazine, horse excrement was used since it is the main object on which the product is applied. In both cases, manure with high levels of fly larvae infestation was selected in order to obtain a suitable number of larvae per test.

In order to carry out the effectiveness tests, a mixture of wood shavings/manure in a proportion of 30/70 was placed on different trays, adding 50 g of wood shavings per 117 g of manure without excessively mixing the materials, which may facilitate the contact between the larvae and the wood shavings treated. The trays were covered with a net in order to prevent any adults from escaping.

With the aim of reproducing at a small scale the conditions of the wood shavings impregnated with IGR and manure in the facilities were horses are kept, the trays were kept in open air in natural conditions, alternating periods of shade with periods under the sun.

In the case of the tests of litters with pyriproxyfen, after 5 days of exposure (enough time for the larvae to progress to the pupal stage), the pupae were separated in plastic cups covered with a net, waiting for the adults to emerge. Once the adults emerged, the unviable pupae and the adults that emerged (healthy and malformed) were counted in order to calculate the mortality rate for each case.

In the case of the test with cyromazine, after the 5 days of exposure the dead pupae and larvae were separated. Once the adults emerged, the dead larvae, the unviable pupae and the adults that emerged (healthy and malformed) were counted in order to calculate the mortality rate for each case.

All the tests included a control group of untreated wood shavings.

### Results

Test 1. Four different formulations were tested in the conditions described in the following table (Table 1). Four formulations were prepared:

TABLE 1
Formulations with pyriproxyfen and
diflubenzuron on rabbit manure

| | | | Dose | Load |
|---|---|---|---|---|
| | IGR Concentration | | (weight of the | (mg of active |
| | (weight in relation | | formulation in | ingredient/ |
| | to the total weight | Type of | relation to the | Kg wood |
| No | of the formulation) | formulation | wood shavings) | shavings) |
| 1 | Diflubenzuron 10% | Concentrated | 6% | 6000 |
| | | suspension | | |
| 2 | Pyriproxyfen 1% | Concentrated | 6% | 600 |
| | | suspension | | |
| 3 | Pyriproxyfen 1% + | Concentrated | 6% + 6% | 600 + 600 |
| | diflubenzuron 10% | suspension | | |
| 4 | Diflubenzuron 100% | Technical | 0.6% | 6000 |
| | | product | | |
| | | sprinkled | | |

Additionally, a control test without wood shavings (C) and another with untreated wood shavings (1) was made. The results of pupal mortality of M. domestica with wood shavings impregnated with the formulations detailed on Table 1 obtained in this first test are shown on Table 2 and FIG. 3.

TABLE 2
Results of pupal mortality of M. Domestica with
wood shavings with the formulations of Table 1

| No | Total individuals | Adults | Unborn pupae | % Mortality |
|---|---|---|---|---|
| C (control) | 109 | 101 | 8 | 7.3 |
| 0 | 142 | 136 | 6 | 4.2 |
| 1 | 181 | 34 | 147 | 81.2 |
| 2 | 161 | 2 | 159 | 98.8 |
| 3 | 182 | 1 | 181 | 99.5 |
| 4 | 222 | 93 | 129 | 58.1 |

The results of this first test were useful to select pyriproxyfen as the insect growth regulator (IGR) active compound of the formulation, since the mortality results for diflubenzuron (formulations 1 and 4) are good but not as good as those of the formulations with pyriproxyfen (formulations 2 and 3).

It should be highlighted that the only non-liquid formulation (formulation 4) shows the worst mortality results, probably due its lower dispersion and adherence to the substrate (wood shavings).

Test 2. Formulations with Pyriproxyfen on Rabbit Manure

The formulations prepared for impregnation were aqueous dispersions and emulsions with different concentrations of pyriproxyfen (Table 3):

TABLE 3
Formulations with pyriproxyfen on rabbit manure

| | | | Dose (weight of | Load |
|---|---|---|---|---|
| | IGR Concentration | | the formulation | (mg of active |
| | (weight in relation | | in relation to the | ingredient/ |
| | to the total weight | Type of | weight of the | Kg wood |
| No | of the formulation) | formulation | wood shavings) | shavings) |
| 1 | Pyriproxyfen 0.5% | Aqueous | 6% | 300 |
| | | dispersion | | |
| 2 | Pyriproxyfen 0.1% | Aqueous | 6% | 150 |
| | | dispersion | | |
| 3 | Pyriproxyfen 1% | Aqueous | 6% | 600 |
| | | dispersion | | |
| 4 | Pyriproxyfen 0.2% | Aqueous | 6% | 150 |
| | | dispersion | | |
| 5 | Pyriproxyfen EW | Aqueous | 6% | 300 |
| | 0.5% | emulsion | | |
| 6 | Pyriproxyfen EW | Aqueous | 6% | 150 |
| | 0.2% | emulsion | | |

As in test 1, a control group with manure and without wood shavings (C) was carried out. The results of pupal mortality of M. domestica with wood shavings impregnated with the formulations of pyriproxyfen detailed on table 3 on rabbit manure are shown on the following table (Table 4) and FIG. 4.

TABLE 4
Results of pupal mortality of M. Domestica with wood shavings
with the formulations of pyriproxyfen of Table 2 on rabbit manure

| No | Total individuals | Adults | Unborn pupae | % Mortality |
|---|---|---|---|---|
| C (control) | 71 | 62 | 9 | 12.7 |
| 1 | 35 | 1 | 34 | 97.1 |
| 2 | 85 | 1 | 84 | 98.8 |
| 3 | 42 | 0 | 42 | 100 |
| 4 | 132 | 0 | 132 | 100 |
| 5 | 112 | 0 | 112 | 100 |
| 6 | 71 | 0 | 71 | 100 |

The results obtained showed the high effectiveness of all the formulations employed for impregnating the wood shavings. The best results (100% mortality) were obtained with the formulations 3, 4, 5 and 6.

In light of these results, the test was repeated impregnating wood shavings with the formulations in a lower concentration of pyriproxyfen and on horse manure.

Test 3. Trays with wood shavings impregnated with two formulations with pyriproxyfen (see Table 5 below) were prepared, and horse manure was applied on them.

Additionally, a tray with untreated wood shavings serving as a control group (C) was prepared.

TABLE 5
Formulations with pyriproxyfen on horse manure

| | Pyriproxyfen | | Dose (weight of | Load |
|---|---|---|---|---|
| | concentration | | the formulation | (mg of active |
| | (weight in relation | | in relation to the | ingredient/ |
| | to the total weight | Type of | weight of the | Kg wood |
| No | of the formulation) | formulation | wood shavings) | shavings) |
| 1 | Pyriproxyfen 0.2% | Aqueous | 6% | 120 |
| | | emulsion | | |
| 2 | Pyriproxyfen 0.1% | Aqueous | 6% | 60 |
| | | emulsion | | |

The results of pupal mortality of M. domestica with wood shavings impregnated with the formulations of pyriproxyfen on horse manure are shown on the following table (Table 6) and FIG. 5.

TABLE 6
Results of pupal mortality of M. Domestica with
wood shavings with the formulations of Table 5

| No | Total individuals | Adults | Unborn pupae | % Mortality |
|---|---|---|---|---|
| C (control) | 53 | 43 | 10 | 19 |
| 1 | 93 | 0 | 93 | 100 |
| 2 | 41 | 0 | 41 | 100 |

Once again, a 100% mortality rate was obtained for both substrates prepared with the formulations of pyriproxyfen, both at 0.2% as well as at 0.1% (Table 6).

Test 4: In light of these results, a final test was prepared with the aim of evaluating the effectiveness of the substrate impregnated with pyriproxyfen solutions in a lower concentration than the ones tested (0.05% and 0.01%), applying them in several doses (3% and 6%) with the aim of optimising the concentration of IGR and the dose applied.

In order to do so a substrate impregnated with the formulations detailed on Table 7 was evaluated:

TABLE 7
Formulations with pyriproxyfen on horse manure

| | Pyriproxyfen | | Dose (weight of | Load |
|---|---|---|---|---|
| | concentration | | the formulation | (mg of active |
| | (weight in relation | | in relation to the | ingredient/ |
| | to the total weight | Type of | weight of the | Kg wood |
| No | of the formulation) | formulation | wood shavings) | shavings) |
| 1 | Pyriproxyfen 0.1% | Aqueous | 6% | 60 |
| | | emulsion | | |
| 2 | Pyriproxyfen 0.05% | Aqueous | 6% | 30 |
| | | emulsion | | |
| 3 | Pyriproxyfen 0.01% | Aqueous | 6% | 6 |
| | | emulsion | | |
| 4 | Pyriproxyfen 0.1% | Aqueous | 3% | 30 |
| | | emulsion | | |
| 5 | Pyriproxyfen 0.05% | Aqueous | 3% | 15 |
| | | emulsion | | |
| 6 | Pyriproxyfen 0.2% | Aqueous | 3% | 60 |
| | | emulsion | | |

The formulation 5 of test 4 includes quantities expressed as percentages of the total weight of the composition:

Pyriproxyfen: 0.05%

Vinyl copolymer: 0.385%

Additional additives: 1.72% (surfactants 0.02%, solvent 1.6%, preservative 0.1%)

water: csp. 100%

The rest of the formulations tested in this study include quantities expressed as percentages of the total weight of the composition:

IGR: As indicated in any of the tables 1, 3, 5 or 7

Vinyl copolymer: 0-5%

Additional additives: 0.5-5%

water: csp. 100%

The additional additives are surfactants, solvents (different from water) and preservatives that provide stability to the formulation.

The results of pupal mortality of M. domestica with wood shavings impregnated with the formulations of pyriproxyfen described on Table 7, on horse manure, are shown on Table 8 and FIG. 6.

TABLE 8
Results of pupal mortality of M. Domestica with
wood shavings with the formulations of Table 7

| | Total | Adults | Unborn | |
|---|---|---|---|---|
| No | individuals | normal | pupae | % Mortality |
| 0 | 39 | 38 | 1 | 2.6 |
| 1 | 71 | 1 | 70 | 98.6 |
| 2 | 79 | 0 | 79 | 100 |
| 3 | 44 | 2 | 42 | 95.5 |
| 4 | 135 | 4 | 131 | 95 |
| 5 | 50 | 2 | 48 | 96 |
| 6 | 47 | 0 | 47 | 100 |

The results obtained attest the good effectiveness of pyriproxyfen as a pupicide even in low doses. Even with formulation 3, in which the quantity of pyriproxyfen per Kg of wood shaving is the lowest (6 mg/Kg), it displays very good effectiveness (95.5%).

Test 5. Four different formulations with cyromazine were tested on horse manure (Table 9):

TABLE 9
Formulations with cyromazine on horse manure

| | | | Dose (weight of | Load |
|---|---|---|---|---|
| | | | the formulation | (mg of active |
| | | | in relation to the | ingredient/ |
| | | Type of | weight of the | Kg wood |
| No | Composition | formulation | wood shavings) | shavings) |
| 1 | Cyromazine 1% | Aqueous | 6% | 600 |
| | | dispersion | | |
| 2 | Cyromazine 0.5% | Aqueous | 3% | 150 |
| | | dispersion | | |
| 3 | Cyromazine 0.5% | Aqueous | 6% | 300 |
| | | dispersion | | |
| 4 | Cyromazine 0.1% | Aqueous | 6% | 60 |
| | | dispersion | | |

Additionally, a control formulation without wood shavings (C) and another with untreated wood shavings (0) were tested.

The results of pupal mortality of M. domestica with wood shavings impregnated with the formulations detailed on Table 9 obtained in this test are shown on Table 10 and FIG. 7.

TABLE 10
Results of pupal mortality of M. Domestica with
wood shavings impregnated with the formulations
of Table 9 containing cyromazine on horse manure

| | Total | | Dead | Unborn | % |
|---|---|---|---|---|---|
| No | individuals | Adults | larvae | pupae | Mortality |
| C (control) | 87 | 80 | 1 | 6 | 8 |
| 0 | 103 | 92 | 2 | 4 | 5.8 |
| 1 | 79 | 0 | 79 | 0 | 100 |
| 2 | 128 | 2 | 124 | 2 | 98.4 |
| 3 | 134 | 1 | 130 | 3 | 99.3 |
| 4 | 117 | 35 | 78 | 4 | 70 |

The results attested the effectiveness of the wood shavings impregnated with cyromazine and, additionally, they provide the information needed to select the ideal concentration of the impregnating formulation and its recommended dose.

The wood shavings treated with formulation 1 displayed the highest effectiveness (100% mortality) but formulations 2 and 3 also obtained a very high mortality rate (98.4% and 99.3% respectively), using a quarter and half of the load of formulation 1 respectively. Therefore, their cost/effectiveness ratio is much better.

The wood shavings impregnated with solution 4 obtained good effectiveness results, but they comparatively did not achieve the high mortality rates of the other formulations, which shows that the active load per kilogram of wood shavings was too low in this case.

In short, this test was able to attest the effectiveness of the final product when the IGR agent is cyromazine, providing a valid option for controlling house flies in animal litters that is the object of the invention. It also provided the information needed to select the concentration of the solution (0.5% cyromazine) and the dose (150 mg/kg of wood shavings). The formulations with very low concentrations of the active ingredient (cyromazine) and very low doses of the product are enough to exert an adequate control of the immature states of M. domestica in manure.

Several conclusions can be drawn from the five tests carried out:
The substrate impregnated with IGRs has proven to be a useful tool for controlling flies in manure;
The IGRs used (pyriproxyfen, diflubenzuron and cyromazine) have proved to be effective in low doses, with pyriproxyfen and cyromazine showing the best mortality rates;
Substrates with loads of 15 mg/kg of pyriproxyfen and even 6 mg/kg, or 150 mg/kg of cyromazine showed high effectiveness for controlling pupae of house flies.
Other factors in addition to its effectiveness should be taken into account when choosing a suitable formulation for impregnation.

While various embodiments of the invention were provided in the foregoing description, those skilled in the art may make modifications and alterations to these embodiments without departing from the scope and spirit of the invention. For example, it is to be understood that this disclosure contemplates that, to the extent possible, one or more features of any embodiment can be combined with one or more features of any other embodiment. Accordingly, the foregoing description is intended to be illustrative rather than restrictive. The invention described hereinabove is defined by the appended claims and all changes to the invention that fall within the meaning and the range of equivalency of the claims are to be embraced within their scope.

1. A substrate for controlling insects, comprising an absorbent substrate impregnated with at least one insect growth regulator.

2. The substrate for controlling insects according to claim 1, wherein the insect growth regulator is selected from the group consisting of pyriproxyfen, methoprene, hydropren, diflubenzuron, triflumuron, fenoxycarb, tebufenozide, metoxifenocide, cyromazine, and a combination thereof.

3. The substrate for controlling insects according to claim 2, wherein the insect growth regulator is selected between pyriproxyfen and cyromazine.

4. The substrate for controlling insects according to claim 1, wherein a concentration of the insect growth regulator in the absorbent substrate is comprised between 1 mg/kg and 6000 mg/kg by weight of a weight of the absorbent substrate.

5. The substrate for controlling insects according to claim 1, comprising an absorbent substrate impregnated with a formulation comprising:
between 0.005 and 10% of at least one insect growth regulator;
between 0% and 5% of at least one film-forming substance;
between 0% and 15% of at least one water insoluble particulate mineral material;
between 0% and 25% of at least one organic solvent;
between 0.01% and 10% of at least one additive selected from the group consisting of emulsifier, thickener, pH regulating agent, antifoaming agent, dispersant, preservative, fungicide, and a combination thereof; and
a quantity of water sufficient to complete 100% of the weight of the formulation.

6. The substrate for controlling insects according to claim 1, wherein the absorbent substrate is selected from the group consisting of wood shavings, straw, wood pellets, paper, hemp, flax, ground cardboard and a combination thereof.

7. A method for obtaining the substrate for controlling insects described in claim 1, wherein the method comprises: applying on an absorbent substrate a formulation comprising, in percentage by weight of a total weight of the formulation:
between 0.005% and 10% of at least one insect growth regulator;
between 0% and 5% of at least one film-forming substance;
between 0% and 15% of at least one water insoluble particulate mineral material;
between 0% and 25% of at least one organic solvent;
between 0.01% and 10% of at least one additive selected from the group consisting of emulsifier, thickener, pH regulating agent, antifoaming agent, dispersant, preservative, fungicide, and a combination thereof; and
a quantity of water sufficient to complete 100% of the weight of the formulation.

8. The method according to claim 7, wherein the formulation is applied by impregnation by means of one of the techniques selected from the group consisting of sprinkling, spraying, fogging and direct contact with a surface impregnated with the composition.

9. The method according to claim 7, wherein the substrate impregnated with the formulation comprising the insect growth regulator has a humidity above 8%, and the method comprises an additional stage for drying the impregnated absorbent substrate to a maximum humidity value of 12% if this value is any higher after impregnation.

10. The method according to claim 7, wherein the insect growth regulator is selected between pyriproxyfen and cyromazine, and the amount of formulation applied is between 2% and 10% by weight of the final weight of the absorbent substrate.

11. The method according to claim 7, wherein the formulation to be applied on the substrate is in concentrated form and comprises the following components in percentage by weight of the total weight of the formulation:
between 1% and 50% of at least one insect growth regulator;
between 0% and 25% of at least one film-forming substance;
between 0% and 50% of at least one water insoluble particulate mineral material;
between 0% and 95% of at least one organic solvent;
between 0.01% and 10% of at least one additive selected from the group consisting of emulsifier, thickener, pH regulating agent, antifoaming agent, dispersant, preservative, fungicide, and a combination thereof; and
the quantity of water sufficient to complete 100% of the weight of the formulation, which may be equal to zero;
so that said concentrated formulation is diluted in water before it is applied on the substrate.

12. The method according to claim 7, wherein the absorbent substrate are wood shavings and the method comprises manufacturing these wood shavings.

13. A method of using a substrate for controlling insects described in claim 1, wherein the method comprises placing the substrate in a place where animals live.

14. A litter for animals made up of the substrate for controlling flies and other insects described in claim 1.

15. A method for preparing an agricultural fertilizer, wherein the method comprises:
accumulating a substrate for controlling insects described in claim 1 previously removed from a place where the substrate was deposited as animals litter together with manure formed thereon, in an open air enclosure; and
placing a transparent plastic sheet on a mixture of the substrate and manure for degrading thereof, making solar radiation increase a temperature inside, and causing active ingredients to degrade.
